(19) United States
(12) Patent Application Publication
(10) Pub. No.: US 2005/0252930 A1
(43) Pub. Date: Nov. 17, 2005

(54) Dispensing system, a dispenser and a source of material to be used therewith

(76) Inventors: Carl D. Contadini, Terryville, CT (US); John J. Dean, Oxford, CT (US)

Correspondence Address: Arthur G. Schaier;Carmody & Torrance LLP, P.O. Box 1110, 50 Leavenworth Street, Waterbury, CT, 06721-1110, US

(21) Appl. No.: 10/843,122

(22) Filed: May 11, 2004

(51) Int. Cl. B67D 5/08

(52) U.S. Cl. 222/52; 222/638; 222/153.14

(57) ABSTRACT

A dispenser configured to discern a specific source of material from a plurality of other sources of material, wherein the specific source of material and the plurality of other sources of material all comprise at least substantially similarly shaped bodies and spray heads, wherein the specific source of material comprises an identifier associated therewith, the identifier not being associated with the plurality of other sources of material. In a preferred embodiment, the dispenser comprises an interrogator, operationally coupled to the controller, for interrogating the identifier to determine whether the source of material is a specific source of material. An actuation mechanism is inhibited from causing the dispensing of the material if the interrogator does not detect the specific source of material. In preferred embodiments, the interrogator may be a sensor or a reader, and the identifier may be a magnet, a barcode, or an RFID transponder that is compatible with the specific interrogator chosen.

### BACKGROUND OF THE INVENTION

The present invention relates generally to dispensers for dispensing “sanitize conditioning” materials or other material, and in particular, to a dispenser and system that prevents the use of counterfeit or bootleg sources of the material to be used therewith.

Many dispensers, especially dispensers for dispensing “sanitize conditioning” materials such as fragrances or deodorizers, are designed to accept replaceable sources of the material such that, when the source is empty, a full replacement can be provided. Such sources come in many forms, including containers, bottles, cans and cartridges (generically, all such containers, bottles, cans and cartridges hereinafter will be referred to as “sources of material”). Such “sources of material” can be pump sprays or aerosol dispensing cartridges, including metered and non-metered, such as those described in U.S. Pat. No. 6,267,297. Such sources of material can even be similar to those described in co-owned U.S. Pat. No. 5,370,829, which require a fan to create an air flow across the surface of the material to be dispensed.

In any event, because the shape of such cartridges are often standard, it is possible for a user to insert a replacement source of material which is not intended to be used with the particular dispenser. Such use of a non-intended cartridge can be either inadvertent or intentional, thus leading to the insertion of a source of a material, which is incompatible with or otherwise should not be dispensed by the particular dispenser. For instance, depending on the size of the container used, it is foreseeable that an aerosol container containing materials other than the desired sanitize conditioning materials, such as paints or cleaning solutions, could be inadvertently or, worse, intentionally inserted, creating highly undesirable or dangerous results. In addition, from the commercial standpoint, it is desirable that only authorized replacement sources be used in the dispenser.

Systems that incorporate a “lockout feature” are known, one such example being described in U.S. Pat. No. 5,613,625, which is owned by the assignee of the present invention and incorporates a projection lockout element that cooperates with a receiving aperture in the cartridge. Another related idea is described in U.S. Pat. No. 4,931,224. However, as will become clear below, the present invention furthers the state of the art in this regard.

Still further, it would be desirable if the dispenser “knows” what kind, type, size or other characteristic source of material is being inserted in the dispenser, so that the dispenser may “know” how best (such as by preprogramming or otherwise) to dispense such material.

What is desired, therefore, is an improved system including but not limited to the dispenser itself, that includes an arrangement for preventing the use of counterfeit or bootleg replacement sources of the material to be dispensed. It is another object of the present invention to provide an improved dispenser that can “know” what kind, type, size or other characteristic source of material is being inserted in the dispenser, so that the dispensing, and control of such dispensing, can be optimized. By “counterfeit” or “bootleg” is meant any source of a material other than the source of the material to be dispensed intended to be used with the dispenser.

### SUMMARY OF THE INVENTION

Accordingly, it is an object of the present invention to provide an improved dispenser for a source of material, such as a sanitize conditioning material, which includes one or more arrangements to discern a specific source of material from a plurality of other similarly shaped sources of material.

Another object of the present invention is to provide an improved dispenser for a source of material, such as a sanitize conditioning material, which permits the use of only authorized sources of the material to be dispensed.

It is another object of the present invention to provide an improved dispenser that can “know” what kind, type, size or other characteristic source of material is being inserted in the dispenser, so that the dispensing, and control of such dispensing, can be optimized.

Another object of the present invention is to provide identifiers that can be hidden from view, such as positioned within the source of material.

Further objects and advantages of this invention will become more apparent from a consideration of the drawings and ensuing description.

The invention accordingly comprises the features of construction, combination of elements, arrangement of parts and methodology that will be exemplified in the disclosure hereinafter set forth, and the scope of the invention will be indicated in the claims.

To overcome the perceived deficiencies in the prior art and to achieve the objects and advantages above and below, the present invention is, generally speaking, directed to a dispenser configured to discern a specific source of material from a plurality of other sources of material, wherein the specific source of material and the plurality of other sources of material all comprise at least substantially similarly shaped bodies in which the material to be dispensed is held and at least substantially similarly shaped heads through which the material exits, wherein the specific source of material comprises an identifier associated therewith, and the plurality of other sources of material either do not have an identifier or have an identifier different from the identifier associated with the specific source of material.

In a preferred embodiment, the dispenser comprises a housing within which a source of material is positionable; an actuation mechanism for causing the dispensing of material from the source of material; a controller, coupled to the actuation mechanism, for controlling the actuation of the actuation mechanism; and an interrogator, operationally coupled to the controller, for interrogating the identifier to determine whether the source of material is a specific source of material and for communicating with the controller.

In one preferred embodiment, the interrogator is a sensor, operationally coupled to and for communicating with the controller, for detecting one or more criterions about the identifier; wherein the actuation mechanism is inhibited from causing the dispensing of the material if the sensor does not detect the one or more criterions about the identifier from a source of material positioned within the housing. In an exemplary embodiment, the one or more criterions may be (i) whether the identifier is detected in the first instance, (ii) whether the identifier is of an expected size and/or (iii) whether the identifier provides an expected or sufficient magnetic field.

In another preferred embodiment, the interrogator is a reader, operationally coupled to and for communicating with the controller, for reading the identifier; wherein the actuation mechanism is inhibited from causing the dispensing of the material if the reader does not read the identifier in the first instance and/or does not read the anticipated information on the identifier from a source of material positioned within the housing. In preferred embodiments, the identifier may be a barcode or an RFID tag.

Still further, a method of inhibiting the dispensing of material from the source of material is provided. In this embodiment, the method comprises the steps of: positioning the source of material in sufficient proximity to the dispenser to permit the dispenser to detect the presence of the identifier associated with the specific source of material; and inhibiting the dispensing of the material if the identifier associated with the specific source of material is not detected by the dispenser.

In yet another embodiment of the present invention, a dispenser for discerning a specific source of material from a plurality of other sources of material, wherein the discerning of the specific source of material from the plurality of other sources of material is to inhibit the dispensing of the material until an interrogation of an area of interest is performed. In a preferred embodiment, the dispenser comprises a housing within which a source of material is positionable; actuation means for dispensing material from the source of material; controller means for controlling the actuation of the actuation means; means for detecting the presence/absence of the identifier and/or for determining one or more criterions about the identifier and for communicating with the controller means, and means for carrying out an interrogation of the area of interest prior to any dispensing of material if the means for detecting does not detect the presence/absence of the identifier and/or one or more criterions about the identifier. In a related embodiment, a method of determining whether an area of interest should be interrogated prior to the dispensing of material from a specific source of material is provided.

In yet other embodiments, sources of materials to carry out the foregoing and below mentioned objectives are provided, as well as systems comprising such a dispenser and source of materials.

To ensure completeness, it should be clearly understood that the present invention is applicable to a variety of dispensers capable of dispensing a material, such as, but not limited to, a sanitize conditioning or other olfactory stimulating material. For example, insecticide and pesticide materials are also contemplated as the material to be dispensed from the dispenser, and as discussed below, it will become readily apparent that the present invention is advantageously utilizable therefore. As such, the disclosures of U.S. Pat. Nos. 5,383,580; 5,370,829; 5,613,625; 5,772,074; 6,039,212; and 6,267,297 are all incorporated by reference as if fully set forth herein. Again, the foregoing list of applicable sources of material are intended to be exemplary and not exhaustive, since other materials are equally applicable, such as one in which the material to be dispensed is present in a solid block of material, such that when heat is applied to the block, the material to be dispensed is vaporized and dispersed to the environment. As will become clear below, one ordinary skilled in the art could easily modify such a block of material in a way so that utilization of the present invention is possible.

### BRIEF DESCRIPTION OF THE DRAWINGS

The above set forth and other features of the invention are made more apparent in the ensuing Description of the Preferred Embodiments when read in conjunction with the attached Drawings, wherein:

FIG. 1 is a perspective view of a dispensing system constructed in accordance with the present invention;

FIG. 2 is a simplified front view, partially broken away, of a dispensing system constructed in accordance with a first embodiment of the present invention, illustrating both a dispenser constructed in accordance with this first embodiment and a source of material constructed in accordance with this first embodiment;

FIG. 3 is a cross-sectional view of the system illustrated in FIG. 2, clearly illustrating certain particular features of the first embodiment of the present invention;

FIG. 4 is a simplified front view, partially broken away, of a dispensing system constructed in accordance with a second embodiment of the present invention, illustrating both a dispenser constructed in accordance with this second embodiment and a source of material constructed in accordance with this second embodiment; and

FIG. 5 is a simplified front view, partially broken away, of a dispensing system constructed in accordance with a third embodiment of the present invention, illustrating both a dispenser constructed in accordance with this third embodiment and a source of material constructed in accordance with this third embodiment.

### DETAILED DESCRIPTION OF THE PREFERRED EMBODIMENTS

Prior to disclosing the details of the present invention, it should be understood that not all components and parts of the present invention are shown and/or marked in all the drawings, although all material and relevant components and parts to enable the present invention and which are part of the best mode are disclosed. In this regard, reference may also be had to those disclosures incorporated by reference for further details or descriptions.

Secondly, the dispensing of a sanitize conditioning material may include materials in liquid form or carried in a gel or like material. “Sanitize conditioning” (or a form thereof) should also be construed in its broadest sense as a material that may freshen, deodorize, sanitizes, disinfect or otherwise condition the air as would be understood in the art. For purposes of this application, “sanitize conditioning” should also be understood to include an insecticide product, and wherein reference to “insecticide” should also be broadly understood to cover herbicides, pesticides, etc. The operation/construction of both systems should be seen as identical.

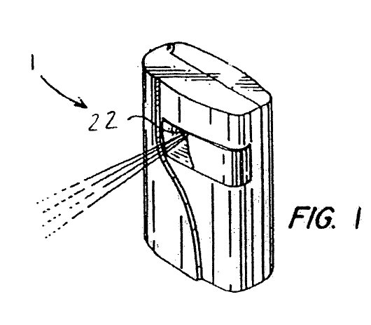

Reference is first made to FIG. 1 which illustrates a dispensing system, generally indicated at 1, constructed in accordance with the present invention. System 1, which may be comprised of one or more dispensers, generally indicated at 5, is preferably constructed to sanitize condition the air within an area of interest (such as a restroom, by way of example and not limitation). Alternatively, dispensing system 1 may be placed in an area of interest where dispensing of an insecticide is desired/necessary. Dispensing system 1 may be positioned on a wall and may be used in connection within a larger system, such as that described in U.S. Pat. No. 6,347,414, the disclosure of which is incorporated by reference as if fully set forth herein. Reference should be made to U.S. Pat. No. 6,347,414 for the details of the general integration of dispensing system 1 with the system disclosed therein.

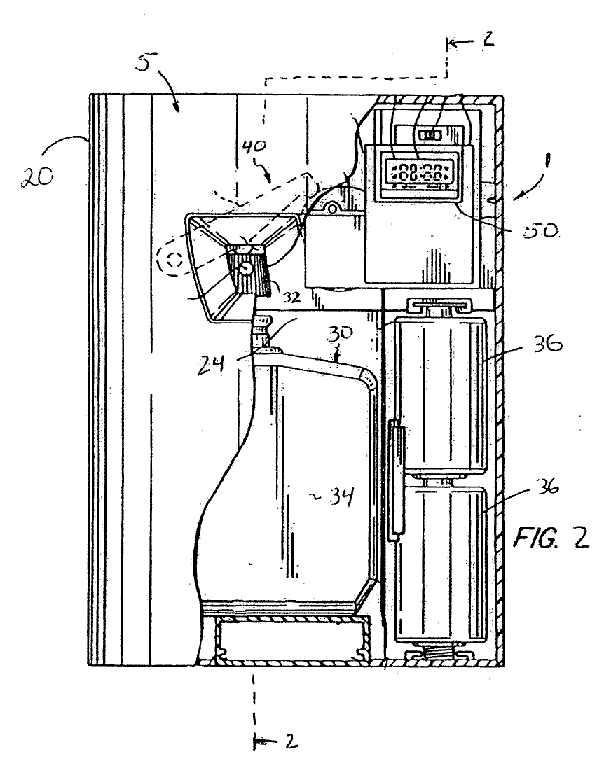

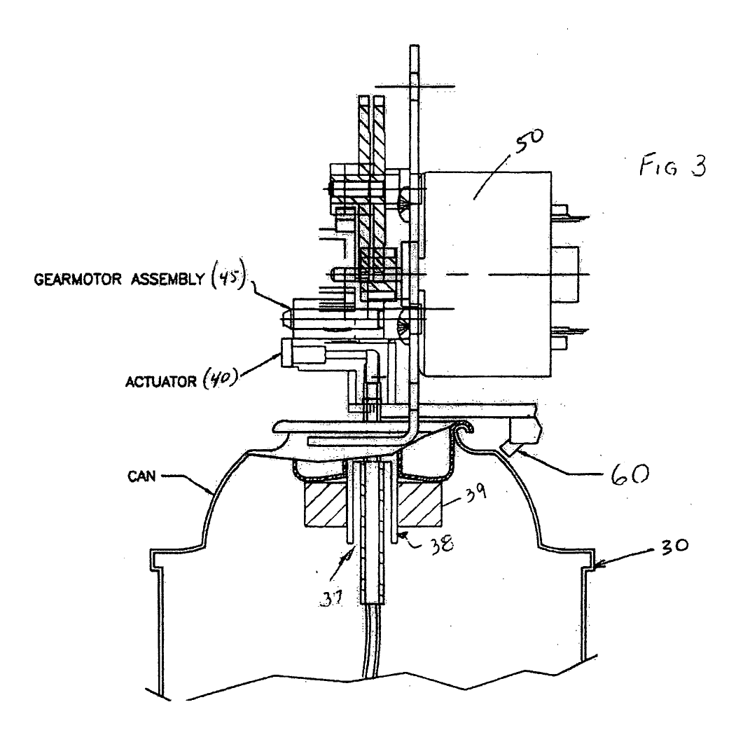

Reference is now also made to FIGS. 2 and 3 for a more detailed disclosure of a first embodiment of the construction of dispensing system 1. For an understanding of the non-material details of the present invention, reference should be had to the disclosures which have been incorporated herein by reference.

Dispensing system 1 generally comprises dispenser 5, which itself includes a housing 20, and a vent 22 through which a sanitize conditioning or insecticide material can be expelled into the area of interest surrounding dispenser 5. Housing 20 can be made of any suitable material, such as plastic, acrylonitrile-butadiene-styrene copolymer (ABS), low or high-density polyethylene, polypropylene or medium impact styrene, and can be made by any suitable method, such as by injection molding. The size and shape of housing 20 is not material to the invention, as should be appreciated by one skilled in the art, provided it is capable of functioning in the manner disclosed below.

Housing 20 includes an internal cavity 24 within which a source of sanitize conditioning or insecticide material (i.e. “source of material”), generally indicated at 30, can be positioned. Cavity 24 of housing 20 is sized to permit insertion of an appropriate source 30 therein. Source 30 preferably comprises a spray head 32 and a reservoir 34 within which the sanitize conditioning material is provided.

Dispenser 5 includes an actuation mechanism, generally indicated at 40, for dispensing the sanitize conditioning material. Generally, actuation mechanism 40 causes the dispensing of the material by the depression of spray head 32. The construction and operation of actuation mechanism 40 is well known in the art, especially after reading the disclosures incorporated by reference herein, as well as other prior art patents. For example, a suitable actuation mechanism for use with the present invention is described in U.S. Pat. No. 3,589,563, and therefore this disclosure is also incorporated by reference as if fully set forth herein. Other suitable actuation mechanisms are also disclosed in U.S. Pat. Nos. 4,063,664 and 5,249,718, these disclosures also being incorporated by reference as if fully set forth herein. Reference to these disclosures will provide the reader with a greater understanding of the workings of the actuating arm and cam, all as they relate to the contact and depression of spray head 32. As would be understood, the cam and actuating arm are driven by a suitable gearing and motor arrangement 45 (FIG. 3), which are powered by a source of energy, such as batteries 36, or by an a/c arrangement (not shown).

Depressing spray head 32 causes sanitize conditioning material to be mechanically expelled, or pumped, through a spray head orifice in spray head 32 and out vent 22 in housing 20. It should also be understood that the sanitize conditioning material may include a propellant component, under pressure, such that depressing spray head 32 forces both the sanitize conditioning material and propellant through the spray head orifice. Such containers are generally referred to as aerosol containers, the construction of which are well-known in the art. Metered sanitize conditioners are therefore also contemplated and covered herein.

In accordance with the present invention, a controller 50, operatively coupled to actuation mechanism 40, controls when actuation mechanism 40 is to cause dispensing of the sanitize conditioning material from source 30. Controller 50 is operatively coupled to actuation mechanism 40, such as through a suitable circuit (not shown), and can control various aspects of actuation mechanism 40, including days of operation, hours of operation, and frequency of actuation. Examples of other parameters/settings that may be programmed into controller 50 to control actuation mechanism 40 are described in U.S. Pat. No. 6,039,212. In this way, actuation mechanism 40 may dispense sanitize conditioning material at certain preset intervals. A suitably designed and implemented controller for use as described above in controlling actuation mechanism 40 would be readily ascertainable by one skilled in the art.

Again, features of dispensing system 1 not material to the present invention, such as for example, the advantageous incorporation of a display for assisting in the programming of controller 50, the incorporation of a keypad to assist therein and means for determining the amount of material that has been dispensed (or for signaling when replacement thereof is necessary or approaching), are omitted herein for purposes of brevity. Similarly, the use of a remote control device, such as one described in the aforementioned U.S. Pat. Nos. 6,039,212 and 6,267,297 may likewise be incorporated into the present invention.

Turning now to the novel features and advantageousness of the present invention, a dispenser constructed in accordance with the present invention is configured to discern a specific source of material from a plurality of other sources of material, wherein the specific source of material and the plurality of other sources of material all comprise at least substantially similarly shaped bodies in which the material to be dispensed is held and at least substantially similarly shaped spray heads through which the material exits.

The present invention achieves this objective by providing, in the specific source of material, a unique identifier associated therewith. As should be understood, the identifier is not to be associated with the plurality of other sources of material. In this way, and generally speaking, if the dispenser cannot determine one or more criterions about the identifier, such as, if it exists in the first place, the actuation mechanism is inhibited from causing the dispensing of the material. The identifier may comprise a magnet, tag, chip, bar code, transponder, or other such means that is capable of providing a unique identification of the source of material and is capable of being interrogated by an interrogator, i.e., sensor or reader, that is compatible with the identifier. In the first embodiment, dispenser 5 includes a sensor as the interrogator, generally indicated at 60 (FIG. 3), which is operationally coupled to controller 50. Sensor 60 detects the one or more criterions about the tag, such criterions including but not limited to, “is the identifier present,” “is the identifier the expected size,” “does the identifier provide a sufficient/expected magnetic field,” and communicates such information (or lack thereof) to controller 50. Such communication can be either wired or wirelessly, and well within the purview of one skilled in the art. In this way, actuation mechanism 40 can be inhibited from causing the dispensing of the material if sensor 60 does not sense the presence of the identifier or an otherwise correct identifier from the source of material positioned within housing 20.

In a preferred embodiment, sensor 60 is a hall-effect sensor. Exemplary sensors in this regard are manufactured by Texas Instruments under the designations TL173L and TL173C, and as such, would be well understood in the art. These sensors are magnetic field sensors designed to provide linear output voltages proportional to the magnetic field they sense.

As such, the present invention contemplates creating the magnetic field by introducing and/or creating a magnet within reservoir 34. In a preferred methodology, this is achieved by installing an unmagnetized metal material 39 onto the valve stem, generally indicated at 38. Preferably, the material 39 is installed “unmagnetized” to ensure that no external and unaccounted for interference (e.g. magnetic fields) adversely affect the production line equipment. Once the valve assembly, generally indicated at 37 has been oriented (preferably while the source 30 is moving down the production line (not shown)) metal material 39 is magnetized either (a) prior to the installation of valve assembly 37 in reservoir 34 or (b) after the valve assembly has been fixedly coupled to the reservoir 34.

With the magnet now securely in reservoir 34 and sensor 60 having the necessary sensitivity to discern magnet 39 in the source of material, and with sensor 60 being able to transmit to the controller a signal indicative of the information about the identifier (i.e. magnet) such as, but not limited to, whether or not its presence is detected and/or whether it is the correct size, etc. (all of which is done by the linear voltage outputted by the sensor), controller 50 can inhibit, by proper signaling (or lack thereof), the actuation of actuation mechanism 40 if the sensor does not sense an “expected” or “proper” identifier from a source of material positioned within housing 20. To be clear, in this first embodiment the identifier is a magnet disposed inside the body of a specific source of material and sensor 60 is a hall-effect sensor that can sense the magnetic field and provide a linear output voltage proportional to a sensed magnetic field when a specific source of material is placed in the housing.

Another novel and advantageous feature of the present invention is therefore to be able to program/set controller 50 so as to accommodate and/or discern differing specific sources of material. In this way, any criterions (i.e. such as those described in copending application Ser. No. 10/118,747, the disclosure of which is incorporated by reference as if fully set forth herein) may be adjustable or customized depending on source 30. Therefore, it would be advantageous for system 1 to be able to determine what type/kind of source is in dispenser 5 prior to any dispensing. Again, although here the term “differing sources of material” is used, it will be understood that in context, all these differing sources are still those that are desirable to be used, as opposed to the differing sources that are “counterfeit” or “bootleg.”

The size of magnet 39 and hence the magnetic field it creates can thus provide a source identification arrangement for identifying the material in source 30. Thus, system 1 can adjust the one or more criterions based on what the material is in source 30. In this way, another novel feature of the present invention is to have a plurality of different types of specific sources of material, each different type having a different sized “tag(s)” disposed inside the body of the source of material; and wherein the sensor can differentiate between different types of specific sources of material based on the magnetic field sensed, and can output differing linear output voltages based thereon.

Still further in this regard, dispenser 5 may include memory, such as, but not necessarily, in controller 50, wherein values associated with the anticipated magnetic fields created by the respectively sized “tags” are stored. In this way, controller 50 determines the type of specific source of material based on the values stored in the memory.

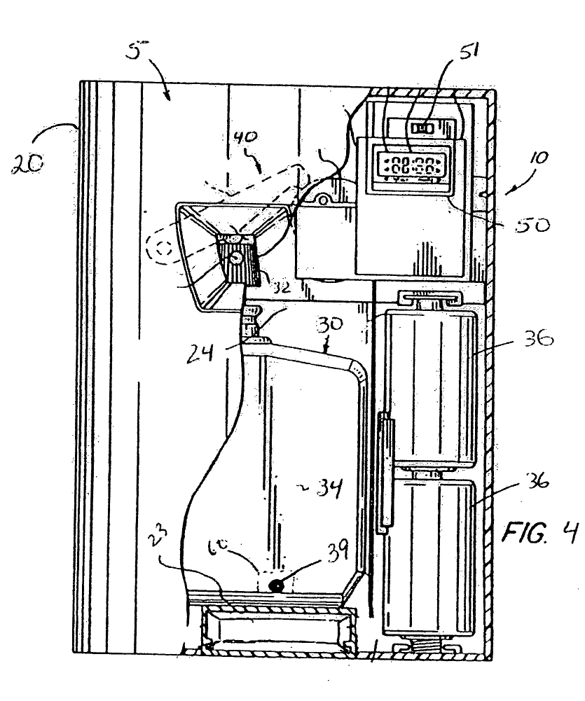

In an alternate embodiment and as illustrated in FIG. 4, the magnetized or unmagnetized member 39 may be in the shape of a ball and placed into reservoir 34 of source 30 at the time of manufacture of source 30. Again, member 39 may be (a) premagnetized or (b) inserted in an unmagnetized state for later magnetization either (i) during the manufacturing process or (ii) as a final step after the construction of source 30 has been completed and prior to sale/distribution.

With such a construction, sensor 60 would have to be repositioned from its location in FIG. 3 to a position closer to the bottom of reservoir 34. Therefore, it would also be preferred that support 23 that supports source of material 30 be angled as shown by the sloping of support 23 towards the rear of housing 20, such that the identifier inside the body of the specific source of material will expectedly and consistently move towards and rest against an inner side wall of the body of the specific source of material. In this way, sensor 60 can be more effectively positioned to ensure accurate and consistent readings of the presence and/or size etc. of the identifier (i.e. by determining the sensed magnetic field).

In either of the embodiments disclosed above, depending on the strength of the magnetic field created when source 30 is put into cavity 24, the particular material in source 30 can now be identified. That is, each type of source can be correspondingly indicated by the size or number of magnets 39, and the magnetic field detected by sensor 60 will change accordingly. In this way, if controller 50 knows the anticipated magnetic field created by the respectively sized or number of magnets 39, determination of the source 30 by the identification arrangement can be made.

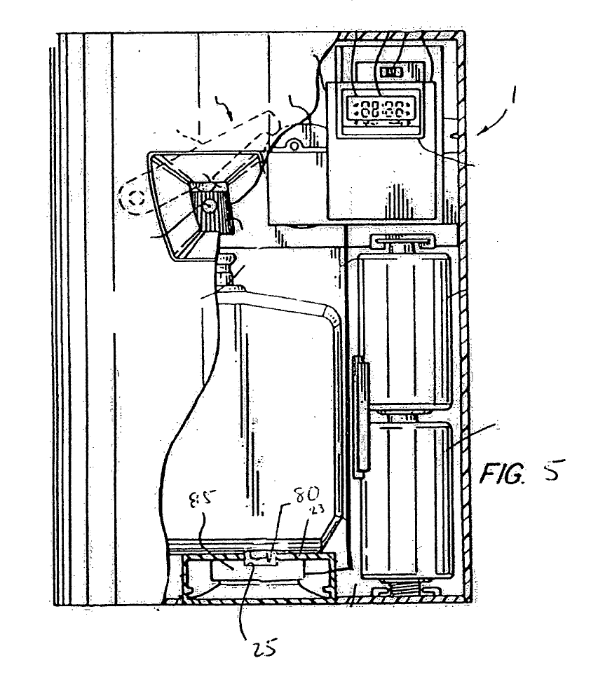

Reference is now made to FIG. 5, wherein yet a third embodiment constructed in accordance with the present invention is disclosed. This third embodiment has much of the same construction as in the first two embodiments, with the material difference being that the identifier is now a barcode, indicated by reference numeral 80, positioned on an outer surface such as (by example and not limitation) the bottom of the body of the specific source of material, and the interrogator is a reader 85 for reading the barcode when the specific source of material is placed on support 23 in the housing. Here, the reader, being operationally coupled to the controller, is an optical reader that reads the barcode, and the actuation mechanism is inhibited from causing the dispensing of the material if the optical reader does not read anticipated information on the barcode from the source of material positioned within the housing. As in the first two embodiments, dispenser 5 can also differentiate between different barcodes of differing (and expected) specific sources of material. To facilitate alignment, support 23 may be provided with a slot 25 or other orientation arrangement to ensure the barcode is properly orientated and hence read by reader 85.

Here too, controller 50 can inhibit the actuation of the actuation mechanism if the reader does not read anticipated information on the barcode from a source of material positioned within the housing.

Therefore, it can be seen that although in a somewhat more different arrangement, the identification arrangement may comprise a barcode in place of magnets 39 (such as on the bottom of, as opposed to in, reservoir 34) and a reader in place of sensor 60.

In another alternate embodiment, radio frequency identification (RFID) technology can be used to discern the specific source of material from a plurality of similarly shaped sources of material. In this embodiment, the source of material may be equipped with a passive transponder tag (identifier) with a (e.g. digital) memory chip that is given a unique electronic product code which cannot be modified, and which may be placed inside or otherwise be associated with the source of material, such as on the bottom, side or otherwise hidden from view. To this end, reference numeral 80 of FIG. 5 could be generically be seen as the RFID identifier. The interrogator (RFID reader), again shown generically as reader 85, which is an antenna packaged with a receiver and decoder, emits a signal that is detected by the RFID transponder tag as it passes through the electromagnetic zone generated by the RFID reader. The RFID reader, being operationally coupled to the controller reads the RFID transponder tag. In accordance with the present invention, the actuation mechanism is inhibited from causing the dispensing of the material if the RFID reader does not detect the RFID transponder tag or read the anticipated information from the RFID tag.

One advantage of the RFID system over conventional barcode technology is that RFID systems are not line-of-sight, and thus do not require a particular orientation of the RFID transponder tag for it to be read by the RFID reader. Thus, RFID transponder tags can be placed in various locations within, on or otherwise associated with the source of material and still provide the necessary information to the RFID reader. As in the other embodiments, dispenser 5 can also differentiate between different RFID transponder tags of differing (and expected) specific sources of material. Here too, controller 50 can inhibit the actuation of the actuation mechanism if the RFID reader does not read anticipated information on the RFID transponder tag from a source of material positioned within the housing. Other embodiments to achieve this function are clearly contemplated hereby, the operative function being that dispenser 5 can identify source 30.

In accordance with all of the foregoing embodiments, a preferred construction to associate the identifier with the specific source of material is to provide the identifier in a position such that it is hidden, such as within the source of material and/or otherwise not readily (or at least easily) viewable or copyable. Accordingly, mounting the identifier in a place or using a method that is not easily or desirably (i.e. bar-coding) copyable is desired. Furthermore, all of the foregoing constructions are patentably distinguishable from a mere mechanical lockout construction.

It can thus be seen that in accordance with the present invention, a method of inhibiting the dispensing of material from a source of material, wherein the dispensing of the material is dispensed from a dispenser that can discern a specific source of material from a plurality of other sources of material all of which comprise at least substantially similarly shaped bodies in which the material to be dispensed is held and at least substantially similarly shaped heads through which the material exits, is provided. In accordance with a preferred embodiment, the specific source of material comprises an identifier associated therewith, and wherein the plurality of other sources of material either do not have an identifier or have an identifier different from the identifier associated with the specific source of material, wherein the method comprises the steps of positioning the source of material in sufficient proximity to the dispenser to permit the dispenser to detect the presence of the identifier associated with the specific source of material; and inhibiting the dispensing of the material if the identifier associated with the specific source of material is not detected by the dispenser. In specific embodiments, the method may comprise the steps of placing the source of material in the dispenser housing, inhibited the material from being dispensed from the specific source of material if the identifier is not of an expected size and/or does not provide an expected or sufficient magnetic field, and/or inhibited the material from being dispensed from the specific source of material if the detector does not read anticipated information on the identifier from the specified source of material.

In yet another embodiment of the present invention, a dispenser that can discern a specific source of material from a plurality of other sources of material as set forth above can now also inhibit the dispensing of the material until an interrogation of the area of interest is performed, if the material in the source is of the type (e.g. has been determined to be of the type) that requires such interrogation, or is for which such interrogation is desirable. However, if the material were of the type whereby no interrogation is needed/desired, the dispenser would thus not perform this interrogation step.

That is, recalling the disclosure and advantages set forth in copending and coowned U.S. patent application Ser. No. 10/118,747, it can now be seen that a further feature of the present invention is to inhibit the dispensing of the material if the dispenser determines that the source of material is one that requires such interrogation prior to its dispensing, and for providing a means for making such determination. For example, the present invention contemplates a dispenser that can accommodate (e.g. dispense material from) various types of sources of material, such as for example and not in a limiting sense, cans holding insecticides and pesticides on the one hand and air freshening material on the other hand. As such, a dispenser that can discern what type of source of material is in the dispenser for the foregoing purpose would be an advantageous feature to have, and would further increase the versatility of the dispenser of the present invention.

Based thereon, the present invention provides for the ability to determine, prior to the dispensing of any material, what type of material has been placed in the dispenser so as to enable the interrogator software and/or hardware to perform (if necessary and/or desirable) the interrogation steps disclosed in the aforementioned application Ser. No. 10/118,747 (and by extension of this application being incorporated herein by reference, in the instant application as well). In this way, the present invention further discloses a dispenser for dispensing a plurality of differing types of materials (e.g. insecticides or pesticides on the one hand, and air fresheners and/or other types of non-insecticide/pesticide sanitize conditioners on the other hand), which determines prior to dispensing the type of source of material to be dispensed if an interrogation of the area of interest is to be performed, and if so, interrogating prior to dispensing the material, at least a portion of the area of interest for the satisfaction of at least one criterion relating to the presence/absence of one or more objects. In a particular embodiment, the interrogation prior to the dispensing of material is of at least a portion of the area of interest to determine whether one or more objects are present in the interrogated portion of the area of interest, which leads to the inhibiting of the dispensing of the material to be dispensed if the one or more objects are present in the interrogated portion of the area of interest. The determination of the type of the source of material is carried out by one or more of the various embodiments set out above.

For example, all insecticide and/or pesticide products may be provided with an identifier as set forth above, while all non-insecticide/pesticides products are not, thereby providing for a step of identifying the existence of the identifier in the first instance. However, since such an embodiment would not necessarily be able to discern a specified source of non-insecticide/pesticide material (e.g. air freshener) from those of third parties (i.e. assuming only the insecticide/pesticide cans are so identified), another embodiment ensures that all sources of materials (e.g. cans) emanating from a single source (e.g. manufacturer) have an identifier associated therewith, with the distinctions between the identifiers of varying types of materials being identifiable/discernable. Thus, other exemplary criterions (singly or in combination) for which the dispenser may be looking for are whether the identifier is of an expected size, whether the identifier provides an expected or sufficient magnetic field, whether the source of material has associated therewith an anticipated identifier, and/or what information is provided on the identifier (e.g. if the identifier is a barcode or transponder “tag,” by way of example). In this way, the step to determine whether an interrogation step should be carried out in the first instance is achieved by identifying the particular type of identifier. The foregoing detailed disclosure sets forth various embodiments for carrying out this method.

For example, in such an embodiment, dispenser 5 can discern a specific source of material from a plurality of other sources of material so as to inhibit the dispensing of the material until an interrogation of an area of interest is performed. For this embodiment, dispenser 5 preferably comprises means for detecting the presence and/or absence of the identifier and/or means for determining (to be used in the present disclosure to be synonymous with “detecting”) one or more criterions about the identifier, such as but not limited to determining (e.g. identifying) the existence of the identifier in the first instance, whether the identifier is of an expected size, whether the identifier provides an expected or sufficient magnetic field, whether the source of material has associated therewith an anticipated identifier, and/or what information is provided on the identifier (e.g. if the identifier is a barcode or transponder “tag,” by way of example). In this way, the step to determine whether an interrogation step should be carried out in the first instance is achieved by identifying a particular type (and/or existence) of the identifier. The associated means for performing the foregoing function are provided by way of reader 80 or sensor 60, by way of example.

If it is determined that an interrogation step should be performed, the controller, such as controller 50, would ensure such an interrogation step is carried out. Such programming for carrying out (or not carrying out) such an interrogation step based on a prior determination (i.e. setting a software flag, etc.) is well within the purview of a skilled artisan. Thereafter, the interrogation step is carried out if needed or not carried out if not needed (i.e. based on the determination of the type/existence of the identifier), all as set forth in application Ser. No. 10/118,747.

Hence, both further embodiments of an improved dispenser and advantages of discerning between sources of material are provided herein. That is, in the improved methodology, a method of determining whether an area of interest should be interrogated prior to the dispensing of material is provided, and includes the steps of determining whether an identifier exists and/or one or more criterions associated with the identifier, and depending on the determination, inhibiting the dispensing of the material until an interrogation of an area of interest is performed. Again, the actual interrogation step is preferably carried out as set forth in greater detail in the aforementioned application Ser. No. 10/118,747.

It can thus be seen that the present invention provides an arrangement to discern a specific source of material from a plurality of other similarly shaped sources of material. Moreover, use of the present invention provides for an improved arrangement for permitting the use of only authorized sources of the material to be dispensed. Still further, the present invention discloses an improved dispenser that can “know” what kind, type, size or other characteristic source of material is being inserted in the dispenser, so that the dispensing, and control of such dispensing, can be optimized. To be clear, the present invention, and the interpretation of the claims should be understood to cover embodiments wherein the dispenser can discern between sources each of which have an anticipated identifier, and sources in which only one has an anticipated identifier.

Although described in the context of preferred embodiments, it should be realized that a number of modifications to these teachings may occur to one skilled in the art. Moreover, while the invention has been particularly shown and described with respect to preferred embodiments thereof, it will be understood by those skilled in the art that changes in form and details may be made therein without departing from the scope and spirit of the invention. For example, detecting the absence of the identifier is the functional equivalent to detecting the presence of the “identifier.” Also the number of “identifiers” can be adjusted as an equivalent to the size of the “identifier.” Likewise, certain terms may be used interchangeably, but this is by way of convenience and not to be viewed in a limiting sense. For example, an “interrogation” of the source of material for the identifier should be understood to be synonymous with the reader, sensor, and/or any other means for detecting or identifying the identifier in a manner set forth herein.

Moreover, the preferred embodiment for which the present invention is disclosed is directed to dispensers for dispensing material into the air, but other dispensers, such as urinals or commodes, should be deemed covered hereby. Moreover, to most appreciate the advantages of the present invention, it is anticipated that the sources of materials will all be essentially, if not identically constructed, thereby making the use of the identifiers disclosed herein even more advantageous and useful for the purposes set forth herein.

1. A dispenser configured to discern a specific source of material from a plurality of other sources of material, wherein the specific source of material and the plurality of other sources of material all comprise at least substantially similarly shaped bodies in which the material to be dispensed is held and at least substantially similarly shaped heads through which the material exits, wherein the specific source of material comprises an identifier associated therewith, the identifier not being associated with the plurality of other sources of material, wherein the dispenser comprises:
a housing within which a source of material is positionable;
an actuation mechanism for causing the dispensing of material from the source of material;
a controller, coupled to the actuation mechanism, for controlling the actuation of the actuation mechanism; and
a sensor, operationally coupled to and for communicating with the controller, for detecting one or more criterions about the identifier.
wherein the actuation mechanism is inhibited from causing the dispensing of the material if the sensor does not detect the one or more criterions about the identifier from a source of material positioned within the housing.

2. The dispenser as claimed in claim 1, wherein the criterions can be (i) whether the identifier is detected in the first instance, (ii) whether the identifier is of an expected size and/or (iii) whether the identifier provides an expected or sufficient magnetic field.

3. The dispenser as claimed in claim 1, wherein the controller inhibits the actuation of the actuation mechanism if the sensor does not detect the one or more criterions about the identifier from a source of material positioned within the housing.

4. The dispenser as claimed in claim 1, wherein the identifier is a magnet disposed inside the body of a specific source of material; and
the sensor is a hall-effect sensor for providing a linear output voltage proportional to a sensed magnetic field when the specific source of material is placed in the housing.

5. The dispenser as claimed in claim 4, wherein there are a plurality of different types of specific sources of material, each different type having a different number and/or size of “identifiers” disposed inside the body of the source of material; and
wherein the sensor can differentiate between different types of specific sources of material based on the magnetic field sensed.

6. The dispenser as claimed in claim 5, including memory, wherein values, associated with the anticipated magnetic fields created by the respectively sized and/or number of “identifiers”, are stored.

7. The dispenser as claimed in claim 6, wherein the controller determines the type of specific source of material based on the values stored in the memory.

8. The dispenser as claimed in claim 5, wherein the controller determines the type of specific source of material based on the output voltage of the sensor.

9. The dispenser as claimed in claim 1, wherein the housing includes a support for supporting a source of material when a source of material is placed in the housing, and
wherein the support is angled such that the identifier inside the body of the specific source of material will move towards and rest against an inner sidewall of the body of the specific source of material.

10. The dispenser as claimed in claim 9, wherein the sensor is positioned in the housing such that it is aligned to read the magnetic field from the identifier when a specific source of material is positioned on the support.

11. A system comprising:
a source of material comprising a body in which the material to be dispensed is held; and a head through which the material exits; wherein the source of material comprises an identifier associated therewith, the identifier not being associated with other sources of material having at least substantially similarly shaped bodies and at least substantially similarly shaped heads; and
a dispenser as claimed in claim 1;
wherein the actuation mechanism is inhibited from causing the dispensing of the material if the sensor does not detect the one or more criterions about the identifier from a source of material positioned within the housing.

12. A dispenser configured to discern a specific source of material from a plurality of other sources of material, wherein the specific source of material and the plurality of other sources of material all comprise at least substantially similarly shaped bodies in which the material to be dispensed is held and at least substantially similarly shaped spray heads through which the material exits, wherein the specific source of material comprises an identifier associated therewith, the identifier not being associated with the plurality of other sources of material, wherein the dispenser comprises:
a housing within which a source of material is positionable;
an actuation mechanism for causing the dispensing of material from the source of material;
a controller, coupled to the actuation mechanism, for controlling the actuation of the actuation mechanism; and
a reader, operationally coupled to and for communicating with the controller, for reading the identifier;
wherein the actuation mechanism is inhibited from causing the dispensing of the material if the reader does not read anticipated information on the identifier from a source of material positioned within the housing.

13. The dispenser as claimed in claim 12, wherein the controller inhibits the actuation of the actuation mechanism if the reader does not read anticipated information on the identifier from a source of material positioned within the housing.

14. The dispenser as claimed in claim 12, wherein the controller inhibits the actuation of the actuation mechanism if the source of material does not comprise an anticipated identifier.

15. The dispenser as claimed in claim 12, wherein the identifier is a barcode positioned on an outer surface of the body of a specific source of material; and
the reader is an optical reader for reading the barcode when the specific source of material is placed in the housing.

16. The dispenser as claimed in claim 15, wherein there are a plurality of different types of specific sources of material, each different type having a different information on its respective barcode; and
wherein the reader can read the information on the barcode of a specific source of material and the dispenser can differentiate between different specific sources of material.

17. The dispenser as claimed in claim 16, including memory, wherein values, associated with the information contained in the barcode, are stored; and
wherein the controller determines the type of specific source of material based on the values stored in the memory.

18. The dispenser as claimed in claim 15, wherein the controller determines the type of specific source of material based on the information on the barcode.

19. The dispenser as claimed in claim 12, wherein the identifier is a RFID transponder tag associated with the specific source of material; and
the reader is an RFID reader for detecting the RFID transponder tag when the specific source of material is placed in the housing.

20. The dispenser as claimed in claim 19, wherein there are a plurality of different types of specific sources of material, each different type having different information associated with its respective RFID transponder tag; and
wherein the reader can read the information associated with the RFID transponder tag of a specific source of material and the dispenser can differentiate between different specific sources of material.

21. The dispenser as claimed in claim 20, including memory, wherein values, associated with the information contained in the RFID transponder tag, are stored; and
wherein the controller determines the type of specific source of material based on the values stored in the memory.

22. The dispenser as claimed in claim 19, wherein the controller determines the type of specific source of material based on the information associated with the RFID transponder tag.

23. A system comprising:
a source of material comprising a body in which the material to be dispensed is held; and a head through which the material exits; wherein the source of material comprises an identifier associated therewith, the identifier not being associated with other sources of material having at least substantially similarly shaped bodies and at least substantially similarly shaped spray heads; and
a dispenser as claimed in claim 12;
wherein the actuation mechanism is inhibited from causing the dispensing of the material if the reader does not detect the identifier.

24. A system comprising:
a source of material comprising:
a body in which the material to be dispensed is held; and
a head through which the material exits;
wherein the source of material comprises an identifier associated therewith, the identifier not being associated with other sources of material having at least substantially similarly shaped bodies and at least substantially similarly shaped heads;
a dispenser, wherein the dispenser is configured to discern the specific source of material from the other sources of material, wherein the dispenser comprises:
a housing within which a source of material is positionable;
actuation means for causing the dispensing of material from the source of material;
controller means, coupled to the actuation means, for controlling the actuation of the actuation means; and
detector means, operationally coupled to and for communicating with the controller, for detecting the identifier;
wherein the dispenser is inhibited from dispensing the material if the identifier is not detected when the source of material is positioned within the housing.

25. The system as claimed in claim 24, wherein, even if the identifier is detected, the dispenser is inhibited from dispensing the material if the identifier is not of an expected size, provides an expected or sufficient magnetic field, and/or has associated therewith expected information.

26. The system as claimed in claim 24, wherein the detector means is a sensor for detecting the presence/absence of the identifier; and wherein the actuation means is inhibited from causing the dispensing of the material if the sensor does not sense the presence of the identifier from a source of material positioned within the housing.

27. The system as claimed in claim 24, wherein the means is a reader for reading the identifier and wherein the actuation means is inhibited from causing the dispensing of the material if the reader does not read anticipated information on the identifier from a source of material positioned within the housing.

28. The system as claimed in claim 27, wherein the reader is one of an optical reader and an RFID reader.

29. A source of material that is discernable by a dispenser that comprises a housing within which the source of material is positionable, an actuation mechanism for causing the dispensing of material from the source of material, a controller coupled to the actuation mechanism for controlling the actuation of the actuation mechanism, and an interrogator operationally coupled to the controller for determining that the source of material is a specific source of material, wherein the actuation mechanism is inhibited from causing the dispensing of the material if the interrogator does not determine that the source of material is a specific source of material, wherein the source of material comprises:
a body that is at least substantially similarly shaped to bodies of other sources of material, wherein the material to be dispensed is held in the body;
a head through which the material exits, the head being at least substantially similarly shaped to the heads of other sources of material; and
an identifier, wherein the identifier is not associated with the plurality of other sources of material; and
wherein the interrogator of the dispenser detects the presence/absence of the identifier and wherein the actuation mechanism is inhibited from causing the dispensing of the material if the interrogator does not sense the presence of the identifier from the source of material when positioned within the housing.

30. A dispenser configured to discern a specific source of material from a plurality of other sources of material, all of which comprise at least substantially similarly shaped bodies in which the material to be dispensed is held and at least substantially similarly shaped heads through which the material exits, wherein the specific source of material comprises an identifier associated therewith and wherein the plurality of other sources of material either do not have an identifier or have an identifier different from the identifier associated with the specific source of material, wherein the dispenser comprises:
a housing within which a source of material is positionable;
actuation means for dispensing material from the source of material;
controller means for controlling actuation of the actuation means; and
interrogator means, operatively coupled to and for communicating with the controller means, for interrogating the identifier to determine whether the source of material is the specific source of material;
wherein the actuation means is inhibited from causing the dispensing of the material if the interrogator determines that the source of material is not the specific source of material.

31. The dispenser as claimed in claim 30, wherein the actuation means is inhibited from causing the dispensing of the material if the interrogator determines that the identifier associated with the specific source of material is not of an expected size and/or does not provide an expected or sufficient magnetic field.

32. The dispenser as claimed in claim 30, wherein the actuation means is inhibited from causing the dispensing of the material if the interrogator does not read anticipated information on the identifier associated with the specified source of material.

33. A dispenser configured to discern a specific source of material from a plurality of other sources of material all of which comprise at least substantially similarly shaped bodies in which the material to be dispensed is held and at least substantially similarly shaped heads through which the material exits, wherein the specific source of material comprises an identifier associated therewith, and wherein the plurality of other sources of material either do not have an identifier or have an identifier different from the identifier associated with the specific source of material, wherein the dispenser comprises:
a housing within which a source of material is positionable;
dispensing means for dispensing of material from the source of material;
controlling means for controlling the actuation of the dispensing means; and
detecting means for detecting the presence of the identifier associated with the specific source of material and for communicating with the controlling means;
wherein the dispensing means is inhibited from dispensing the material from the specific source of material if the detecting means does not detect the presence of the identifier from the specific source of material positioned within the housing.

34. The dispenser as claimed in claim 33, wherein the identifier associated with the specific source of material is one of a different size, provides a different magnetic field, or has associated therewith different information from that associated with the identifiers associated with the plurality of other sources of material.

35. A dispenser configured to discern a specific source of material from a plurality of other sources of material all of which comprise at least substantially similarly shaped bodies in which the material to be dispensed is held and at least substantially similarly shaped heads through which the material exits, wherein the specific source of material comprises an identifier associated therewith, and wherein the plurality of other sources of material either do not have an identifier or have an identifier different from the identifier associated with the specific source of material, wherein the dispenser comprises:
a housing within which a source of material is positionable;
an actuation mechanism for dispensing material from the source of material;
a controller for controlling the actuation of the actuation mechanism; and
a detector for detecting the presence of the identifier associated with the specific source of material and for communication with the controller;
wherein the actuation mechanism is inhibited from dispensing the material from the specific source of material if the detector does not detect the presence of the identifier from the specific source of material.

36. A method of inhibiting the dispensing of material from a source of material, wherein the dispensing of the material is dispensed from a dispenser that can discern a specific source of material from a plurality of other sources of material all of which comprise at least substantially similarly shaped bodies in which the material to be dispensed is held and at least substantially similarly shaped heads through which the material exits, wherein the specific source of material comprises an identifier associated therewith, and wherein the plurality of other sources of material either do not have an identifier or have an identifier different from the identifier associated with the specific source of material, wherein the method comprises the steps of:
positioning the source of material in sufficient proximity to the dispenser to permit the dispenser to detect the presence of the identifier associated with the specific source of material; and
inhibiting the dispensing of the material if the identifier associated with the specific source of material is not detected by the dispenser.

37. The method as claimed in claim 36, including the step of placing the source of material in the dispenser housing.

38. The method as claimed in claim 36, including the step of inhibited the material from being dispensed from the specific source of material if the identifier is not of an expected size and/or does not provide an expected or sufficient magnetic field.

39. The method as claimed in claim 36, including the step of inhibited the material from being dispensed from the specific source of material if the detector does not read anticipated information on the identifier from the specified source of material.

40. A dispenser for discerning a specific source of material from a plurality of other sources of material all of which comprise at least substantially similarly shaped bodies in which the material to be dispensed is held and at least substantially similarly shaped heads through which the material exits, wherein the specific source of material comprises an identifier associated therewith, and wherein the plurality of other sources of material either do not have an identifier or have an identifier different from the identifier associated with the specific source of material, wherein the discerning of the specific source of material from the plurality of other sources of material is to inhibit the dispensing of the material until an interrogation of an area of interest is performed, wherein the dispenser comprises:
a housing within which a source of material is positionable;
actuation means for dispensing material from the source of material;
controller means for controlling the actuation of the actuation means; and
means for detecting the presence/absence of the identifier and/or for determining one or more criterions about the identifier and for communicating said detection with the controller means,
means for carrying out an interrogation of the area of interest prior to any dispensing of material if the means for detecting does not detect the presence/absence of the identifier and/or one or more criterions about the identifier.

41. A method of determining whether an area of interest should be interrogated prior to the dispensing of material from a specific source of material selected from a plurality of other sources of material all of which comprise at least substantially similarly shaped bodies in which the material to be dispensed is held and at least substantially similarly shaped heads through which the material exits, wherein the specific source of material comprises an identifier associated therewith, and wherein the plurality of other sources of material either do not have an identifier or have an identifier different from the identifier associated with the specific source of material, the method comprising the steps of:
with respect to the specific source of material, detecting whether an identifier exists and/or one or more criterions associated with the identifier are present; and
if the identifier associated with the specific source of material is not detected and/or one or more of the criterions associated with the identifier are not determined:
inhibiting the dispensing of material from the specific source of material until an interrogation of an area of interest is performed.

42. The method as claimed in claim 41, wherein the interrogation of the area of interest comprises the step of interrogating at least a portion of the area of interest for the satisfaction of at least one criterion relating to the presence/absence of one or more objects.

43. The method as claimed in claim 42, wherein the interrogation of the area of interest comprises the steps of interrogating at least a portion of the area of interest to determine whether one or more objects are present in the interrogated portion of the area of interest; and
inhibiting of the dispensing of the material to be dispensed if the one or more objects are present in the interrogated portion of the area of interest.
